(19) United States
(12) Patent Application Publication
(10) Pub. No.: US 2024/0038426 A1
(43) Pub. Date: Feb. 1, 2024

(54) CERAMIC COMPOSITION AND WIRE-WOUND COIL COMPONENT

(71) Applicant: Murata Manufacturing Co., Ltd., Kyoto-fu (JP)

(72) Inventors: Atsushi SHIMAMURA, Nagaokakyo-shi (JP); Yuuki KITADAI, Nagaokakyo-shi (JP); Takanori SUZUKI, Nagaokakyo-shi (JP)

(73) Assignee: Murata Manufacturing Co., Ltd., Kyoto-fu (JP)

(21) Appl. No.: 18/328,580

(22) Filed: Jun. 2, 2023

(30) Foreign Application Priority Data
Jul. 26, 2022 (JP) 2022-118829

(51) Int. Cl. H01F 3/08; H01F 27/30; C04B 35/26

(52) U.S. Cl. CPC H01F 3/08; H01F 27/306; C04B 35/265; H01F 27/292

(57) ABSTRACT

The ceramic composition contains Fe, Cu, Zn, Ni, Mn, Nb, and V. When the amounts of Fe, Cu, Zn, and Ni are respectively expressed in terms of Fe₂O₃, CuO, ZnO, and NiO, and a total amount of Fe₂O₃, CuO, ZnO, and NiO is 100 mol %, the ceramic composition contains from 46.70 mol % to 49.70 mol % of Fe in terms of Fe₂O₃, from 4.00 mol % to 7.50 mol % of Cu in terms of CuO, and from 7.00 mol % to 33.50 mol % of Zn in terms of ZnO, with the balance being Ni, and contains from 300 ppm to 10,000 ppm of Mn in terms of Mn₂O₃, from 2 ppm to 30 ppm of Nb in terms of Nb₂O₅, and from 10 ppm to 60 ppm of V in terms of V₂O₅ with respect to 100 parts by weight of the total amount of Fe₂O₃, CuO, ZnO, and NiO.

### CROSS-REFERENCE TO RELATED APPLICATION

This application claims benefit of priority to Japanese Patent Application No. 2022-118829, filed Jul. 26, 2022, the entire content of which is incorporated herein by reference.

### BACKGROUND

### Technical Field

The present disclosure relates to a ceramic composition and a wire-wound coil component.

### Background Art

Japanese Unexamined Patent Application Publication No. 2018-125397 discloses a wire-wound coil device including a drum core having a winding core part and a flange part. The coil device disclosed in Japanese Unexamined Patent Application Publication No. 2018-125397 has high thermal shock resistance because a first protrusion for mounting formed on a flange part at one end portion of the winding core part is offset from a second protrusion for mounting formed on a flange part at the other end portion of the winding core part.

### SUMMARY

Japanese Unexamined Patent Application Publication No. 2018-125397 discloses that the drum core is produced by, for example, molding and sintering a ferrite material, such as Ni—Zn ferrite or Mn—Zn ferrite.

However, the core made of the ferrite material may chip in barrel polishing or may crack in thermocompression bonding between a wire and terminal electrodes. When the terminal electrodes are formed on the bottom surfaces of the core by plating, the plating layer may be displaced from the intended position, which is a defect called “plating elongation”.

Accordingly, the present disclosure is directed to a ceramic composition that is less likely to chip in barrel polishing, crack in thermocompression bonding, or cause plating elongation and that has high specific electrical resistance. The present disclosure is also directed to a wire-wound coil component that includes the ceramic composition as a ceramic core.

A ceramic composition of the present disclosure contains Fe, Cu, Zn, Ni, Mn, Nb, and V, wherein, when amounts of Fe, Cu, Zn, and Ni are respectively expressed in terms of Fe₂O₃, CuO, ZnO, and NiO, and a total amount of Fe₂O₃, CuO, ZnO, and NiO is 100 mol %, the ceramic composition contains 46.70 mol % or more and 49.70 mol % or less (i.e., from 46.70 mol % to 49.70 mol %) of Fe in terms of Fe₂O₃, 4.00 mol % or more and 7.50 mol % or less (i.e., from 4.00 mol % to 7.50 mol %) of Cu in terms of CuO, and 7.00 mol % or more and 33.50 mol % or less (i.e., from 7.00 mol % to 33.50 mol %) of Zn in terms of ZnO, with the balance being Ni, and contains 300 ppm or more and 10,000 ppm or less (i.e., from 300 ppm to 10,000 ppm) of Mn in terms of Mn₂O₃, 2 ppm or more and 30 ppm or less (i.e., from 2 ppm to 30 ppm) of Nb in terms of Nb₂O₅, and 10 ppm or more and 60 ppm or less (i.e., from 10 ppm to 60 ppm) of V in terms of V₂O₅ with respect to 100 parts by weight of the total amount of Fe₂O₃, CuO, ZnO, and NiO.

A wire-wound coil component of the present disclosure includes a ceramic core including a winding core part extending in a length direction, and a pair of flange parts on opposite end portions of the winding core part, the opposite end portions facing each other in the length direction. The flange parts each include an inner end surface facing the winding core part in the length direction, an outer end surface opposite to the inner end surface in the length direction, a pair of side surfaces facing each other in a width direction, and a top surface and a bottom surface facing each other in a height direction. The wire-wound coil component also includes a terminal electrode disposed at least on the bottom surface of each flange part of the ceramic core; and a wire wound around the winding core part of the ceramic core and having end portions electrically connected to the respective terminal electrodes. The ceramic core is composed of the ceramic composition of the present disclosure.

The present disclosure is directed to a ceramic composition that is less likely to chip in barrel polishing, crack in thermocompression bonding, or cause plating elongation and that has high specific electrical resistance. The present disclosure is also directed to a wire-wound coil component that includes the ceramic composition as a ceramic core.

### BRIEF DESCRIPTION OF THE DRAWINGS

FIG. 1 is a schematic view of an example surface of a ceramic composition of the present disclosure;

FIG. 2 is a schematic view of an example polished surface of the ceramic composition of the present disclosure;

FIG. 3 is a schematic front view of an example wire-wound coil component of the present disclosure; and

FIG. 4 is a schematic perspective view of an example ceramic core in the wire-wound coil component illustrated in FIG. 3.

### DETAILED DESCRIPTION

A ceramic composition and a wire-wound coil component of the present disclosure will be described below.

However, the present disclosure is not limited to the following configurations and can be appropriately modified and applied without changing the spirit of the present disclosure. A combination of two or more individual preferred configurations of the present disclosure described below is also within the present disclosure.

Ceramic Composition

The ceramic composition of the present disclosure contains Fe, Cu, Zn, Ni, Mn, Nb, and V. The ceramic composition of the present disclosure contains, for example, ferrite, preferably a spinel ferrite, as a main component.

In this specification, the ceramic composition refers to a sintered compact, preferably refers to a core-shaped sintered compact. Therefore, the ceramic composition of the present disclosure contains the above atoms mixed in an atomic level. In other words, the ceramic composition of the present disclosure has the same definition as a ferrite sintered compact.

When the amounts of Fe, Cu, Zn, and Ni are respectively expressed in terms of Fe₂O₃, CuO, ZnO, and NiO, and the total amount of Fe₂O₃, CuO, ZnO, and NiO is 100 mol %, the ceramic composition of the present disclosure contains 46.70 mol % or more and 49.70 mol % or less (i.e., from 46.70 mol % to 49.70 mol %) of Fe in terms of Fe₂O₃, 4.00 mol % or more and 7.50 mol % or less (i.e., from 4.00 mol % to 7.50 mol %) of Cu in terms of CuO, and 7.00 mol % or more and 33.50 mol % or less (i.e., from 7.00 mol % to 33.50 mol %) of Zn in terms of ZnO, with the balance being Ni.

The ceramic composition of the present disclosure further contains 300 ppm or more and 10,000 ppm or less (i.e., from 300 ppm to 10,000 ppm) of Mn in terms of Mn₂O₃, 2 ppm or more and 30 ppm or less (i.e., from 2 ppm to 30 ppm) of Nb in terms of Nb₂O₅, and 10 ppm or more and 60 ppm or less (i.e., from 10 ppm to 60 ppm) of V in terms of V₂O₅ with respect to 100 parts by weight of the total amount of Fe₂O₃, CuO, ZnO, and NiO.

The ceramic composition of the present disclosure containing Fe, Cu, Zn, Ni, Mn, Nb, and V in the ranges described above is less likely to chip in barrel polishing, crack in thermocompression bonding, or cause plating elongation and can have high specific electrical resistance. For example, the ceramic composition of the present disclosure exhibits a core chipping rate of 0.15% or less in barrel polishing, a crack generation rate of 0.20% or less in thermocompression bonding, a plating elongation of 70 μm or less, and a specific electrical resistance (log ρ) of 1.0×10⁸ Ωm or more. The core chipping rate, the crack generation rate, the plating elongation, and the specific electrical resistance are described below in Examples.

The ceramic composition of the present disclosure may further contain Co. In this case, the ceramic composition of the present disclosure preferably contains 500 ppm or more and 6,000 ppm or less (i.e., from 500 ppm to 6,000 ppm) of Co in terms of CoO with respect to 100 parts by weight of the total amount of Fe₂O₃, CuO, ZnO, and NiO. The ceramic composition of the present disclosure containing Co in this range can further reduce or prevent plating elongation.

The amount of each element can be determined by analyzing the composition of the ceramic composition using inductively coupled plasma atomic emission spectroscopy/mass spectrometry (ICP-AES/MS).

The ceramic composition of the present disclosure may further contain other elements. The ceramic composition of the present disclosure may further contain incidental impurities.

The ceramic composition of the present disclosure preferably has an average grain size of 2.2 μm or more and 9.0 μm or less (i.e., from 2.2 μm to 9.0 μm) in the sintered state. The ceramic composition of the present disclosure having an average grain size in this range is still less likely to chip in barrel polishing.

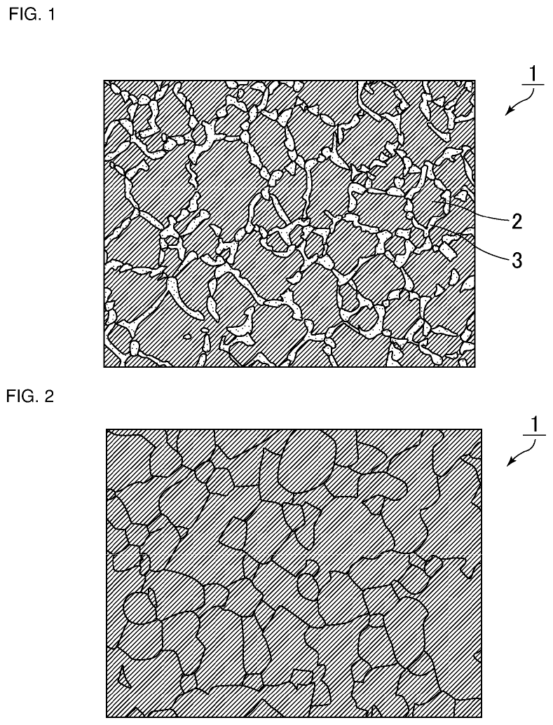

FIG. 1 is a schematic view of an example surface of the ceramic composition of the present disclosure.

A ceramic composition 1 illustrated in FIG. 1 includes grains 2 and grain boundary layers 3 between the grains 2. A large amount of Cu component may precipitate at the grain boundary layers 3, and plating may elongate along the grain boundary layers 3.

FIG. 2 is a schematic view of an example polished surface of the ceramic composition of the present disclosure.

As described below in Examples, the average grain size of the ceramic composition is obtained as the average value of grain sizes calculated from the polished surface of the ceramic composition 1 illustrated in FIG. 2.

The grain size of the ceramic composition can be controlled by the firing temperature, the composition, and other factors. For example, the grain size can increase with increasing firing temperature. The grain size can increase with increasing Cu content in the ceramic composition.

The ceramic composition of the present disclosure is preferably produced as described below.

First, Fe₂O₃, CuO, ZnO, NiO, Mn₂O₃, Nb₂O₅, and V₂O₅ and optional CoO are weighed such that the composition after firing becomes a predetermined composition, and the mixed raw materials are placed in a ball mill together with pure water and PSZ (partially stabilized zirconia) balls and mixed and milled in a wet process for a predetermined time (e.g., 4 hours or more and 8 hours or less (i.e., from 4 hours to 8 hours)). The resulting material is dried by evaporation and then calcined at a predetermined temperature (e.g., 700° C. or higher and 800° C. or lower (i.e., from 700° C. to 800° C.)) for a predetermined time (e.g., 2 hours or more and 5 hours or less (i.e., from 2 hours to 5 hours)) to produce a calcined material (calcined powder).

The obtained calcined material (calcined powder) is placed in a ball mill together with pure water, polyvinyl alcohol serving as a binder, a dispersant, a plasticizer, and PSZ balls, and mixed and milled in a wet process. The mixed and milled slurry is dried into granules in a spray dryer to produce a granule powder.

The produced granule powder is press-molded in a mold into a green compact.

Next, the green compact is maintained and fired in a firing furnace at a predetermined temperature (e.g., 1,000° C. or higher and 1,200° C. or lower (i.e., from 1,000° C. to 1,200° C.)) for a predetermined time (e.g., 2 hours or more and 5 hours or less (i.e., from 2 hours to 5 hours)). The ceramic composition is produced in the process described above.

The ceramic composition of the present disclosure is used as, for example, a ceramic core of a wire-wound coil component. The ceramic composition of the present disclosure does not have any limit on its application and may be used as, for example, an element body of a multilayer inductor or other components.

Wire-Wound Coil Component

The wire-wound coil component of the present disclosure includes the ceramic composition of the present disclosure as a ceramic core.

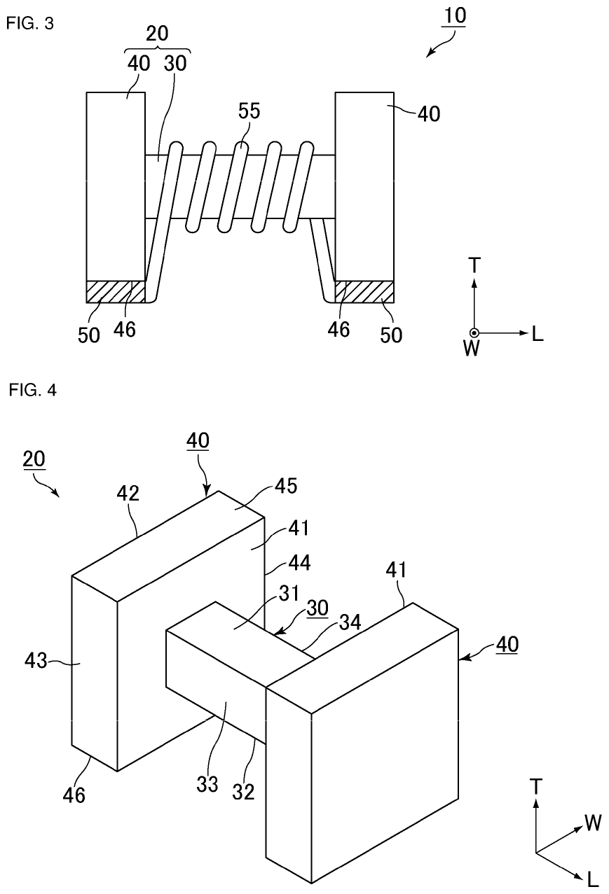

FIG. 3 is a schematic front view of an example wire-wound coil component of the present disclosure. FIG. 4 is a schematic perspective view of an example ceramic core in the wire-wound coil component illustrated in FIG. 3.

FIG. 3 and FIG. 4 are schematic views, and the size and the aspect ratio are not necessarily drawn to scale.

In the following description, the terms (e.g., “perpendicular”, “parallel”, and “orthogonal”) expressing the relationship between elements and the terms expressing the shapes of elements do not have only strict meanings but have meanings in substantially equivalent ranges, that is, include a difference of, for example, about several percentages.

A wire-wound coil component 10 illustrated in FIG. 3 includes a ceramic core 20, a terminal electrode 50, and a wire (coil) 55. The ceramic core 20 is composed of the ceramic composition of the present disclosure.

Referring to FIG. 3 and FIG. 4, the ceramic core 20 includes a winding core part 30 extending in the length direction L and a pair of flange parts 40 on opposite end portions of the winding core part 30 facing each other in the length direction L. The winding core part 30 and the flange parts 40 are integrally formed.

In this specification, referring to FIG. 3 and FIG. 4, the direction in which the pair of flange parts 40 are arranged is defined as the length direction L, the vertical direction in FIG. 3 and FIG. 4 among directions orthogonal to the length direction L is defined as the height direction (thickness direction) T, and the direction orthogonal to both the length direction L and the height direction T is defined as the width direction W.

The winding core part 30 has, for example, a cuboid shape extending in the length direction L. The central axis of the winding core part 30 extends parallel to the length direction L. The winding core part 30 has a pair of main surfaces 31 and 32 facing each other in the height direction T and a pair of side surfaces 33 and 34 facing each other in the width direction W.

In this specification, cuboid shapes include cuboids with chamfered vertices and ridges and cuboids with rounded vertices and ridges. The main surfaces and the side surfaces may partially or entirely have, for example, recesses and/or projections.

The pair of flange parts 40 are disposed on the opposite end portions of the winding core part 30 in the length direction L. Each flange part 40 has a cuboid shape that is thin in the length direction L. Each flange part 40 protrudes around the winding core part 30 in the height direction T and the width direction W. Specifically, the planar shape of each flange part 40 as viewed in the length direction L protrudes from the winding core part 30 in the height direction T and the width direction W.

Each flange part 40 has an inner end surface 41 facing the winding core part 30 in the length direction L, an outer end surface 42 opposite to the inner end surface 41 in the length direction L, a pair of side surfaces 43 and 44 facing each other in the width direction W, and a top surface 45 and a bottom surface 46 facing each other in the height direction T. The inner end surface 41 of one flange part 40 opposes the inner end surface 41 of the other flange part 40.

The inner end surface 41 of each flange part 40 is formed such that, for example, the entire inner end surface 41 extends perpendicular to the direction (length direction L in this case) in which the central axis of the winding core part 30 extends. In other words, the entire inner end surface 41 of each flange part 40 extends parallel to the height direction T. The inner end surface 41 of each flange part 40 may have an inclined surface.

Referring to FIG. 3, the terminal electrode 50 is disposed at least on the bottom surface 46 of each flange part 40. The terminal electrode 50 is, for example, electrically connected to an electrode of a circuit board when the wire-wound coil component 10 is mounted on the circuit board. The terminal electrode 50 is made of, for example, a Ni alloy, such as nickel (Ni)-chromium (Cr) or Ni-copper (Cu), or silver (Ag), Cu, or tin (Sn).

A wire 55 is wound around the winding core part 30. The wire 55 includes, for example, a core wire containing a conductive material, such as Cu, as a main component, and an insulating material, such as polyurethane or polyester, covering the core wire. The opposite end portions of the wire 55 are electrically connected to the respective terminal electrodes 50.

Although not illustrated in FIG. 3, two or more terminal electrodes 50 may be disposed on the bottom surface 46 of each flange part 40. Two or more wires 55 may be wound around the winding core part 30.

The wire-wound coil component of the present disclosure may be produced, for example, as described below.

As described above in [Ceramic Composition], the granule powder is press-molded into a green compact. Next, the green compact is maintained and fired in a firing furnace at a predetermined temperature (e.g., 1,000° C. or higher and 1,200° C. or lower (i.e., from 1,000° C. to 1,200° C.)) for a predetermined time (e.g., 2 hours or more and 5 hours or less (i.e., from 2 hours to 5 hours)). The obtained sintered compact is placed in a barrel and polished with a polishing material. The barrel polishing removes burrs from the sintered compact to make the outer surface (particularly vertices and ridges) of the sintered compact curved and rounded. The ceramic core as illustrated in FIG. 4 is produced in the process described above.

Subsequently, a terminal electrode is formed at least on the bottom surface of each flange part of the ceramic core. For example, a conductive paste containing Ag, a glass frit, and other components is applied to the bottom surface of each flange part and baked at a predetermined temperature (e.g., 800° C. or higher and 820° C. or lower (i.e., from 800° C. to 820° C.)) to form an underlying metal layer. A Ni-plating film and a Sn-plating film are then sequentially formed on the underlying metal layer by electrolytic plating to form a plating layer. Alternatively, a metal terminal may be attached to the bottom surface of each flange part and used as a terminal electrode.

Next, a wire is wound around the winding core part of the ceramic core, and then the end portions of the wire are bonded to the respective terminal electrodes by a known technique, such as thermocompression bonding. The wire-wound coil component as illustrated in FIG. 3 can be produced in the process described above.

The wire-wound coil component of the present disclosure is not limited only to the embodiment described above, and various adaptations and modifications can be made without departing from the scope of the present disclosure. The wire-wound coil component of the present disclosure may have other shapes and may include, for example, a top plate that extends in the length direction L and connects the flange parts to each other. The outer surface of the wire may be coated with a resin. The core is not limited to a drum core and may be an annular core.

The shape and size of the winding core part of the ceramic core, the shape and size of the flange parts of the ceramic core, the wire thickness (wire diameter), the winding number (the number of turns), the cross-sectional shape of the wire, and the number of wires in the wire-wound coil component of the present disclosure are not limited and can be appropriately changed according to the desired characteristics and the mounting location. The position and number of terminal electrodes can be appropriately set according to the number of wires and the intended use.

This specification discloses the following contents.

<1> A ceramic composition containing Fe, Cu, Zn, Ni, Mn, Nb, and V, wherein, when amounts of Fe, Cu, Zn, and Ni are respectively expressed in terms of Fe₂O₃, CuO, ZnO, and NiO, and a total amount of Fe₂O₃, CuO, ZnO, and NiO is 100 mol %, the ceramic composition contains 46.70 mol % or more and 49.70 mol % or less (i.e., from 46.70 mol % to 49.70 mol %) of Fe in terms of Fe₂O₃, 4.00 mol % or more and 7.50 mol % or less (i.e., from 4.00 mol % to 7.50 mol %) of Cu in terms of CuO, and 7.00 mol % or more and 33.50 mol % or less (i.e., from 7.00 mol % to 33.50 mol %) of Zn in terms of ZnO, with the balance being Ni. Also, the ceramic composition contains 300 ppm or more and 10,000 ppm or less (i.e., from 300 ppm to 10,000 ppm) of Mn in terms of Mn₂O₃, 2 ppm or more and 30 ppm or less (i.e., from 2 ppm to 30 ppm) of Nb in terms of Nb₂O₅, and 10 ppm or more and 60 ppm or less (i.e., from 10 ppm to 60 ppm) of V in terms of V₂O₅ with respect to 100 parts by weight of the total amount of Fe₂O₃, CuO, ZnO, and NiO.

<2> The ceramic composition according to <1>, wherein the ceramic composition has an average grain size of 2.2 μm or more and 9.0 μm or less (i.e., from 2.2 μm to 9.0 μm) in a sintered state.

<3> The ceramic composition according to <1> or <2>, further containing 500 ppm or more and 6,000 ppm or less (i.e., from 500 ppm to 6,000 ppm) of Co in terms of CoO with respect to 100 parts by weight of the total amount of Fe₂O₃, CuO, ZnO, and NiO.

<4> A wire-wound coil component including a ceramic core including a winding core part extending in a length direction; and a pair of flange parts on opposite end portions of the winding core part, the opposite end portions facing each other in the length direction. the flange parts each includes an inner end surface facing the winding core part in the length direction, an outer end surface opposite to the inner end surface in the length direction, a pair of side surfaces facing each other in a width direction, and a top surface and a bottom surface facing each other in a height direction. The wire-wound coil component further includes a terminal electrode disposed at least on the bottom surface of each flange part of the ceramic core; and a wire wound around the winding core part of the ceramic core and having end portions electrically connected to the respective terminal electrode. Also, the ceramic core is composed of the ceramic composition according to any one of <1> to <3>.

### EXAMPLES

Examples, which more specifically disclose the ceramic composition of the present disclosure, will be described below. The present disclosure is not limited only to these Examples.

### Example 1

First, Fe₂O₃, CuO, ZnO, NiO, Mn₂O₃, Nb₂O₅, and V₂O₅ were weighed such that the compositions after firing were as described in Table 1, and the mixed raw materials were placed in a ball mill together with pure water and PSZ balls, and mixed and milled in a wet process for 4 hours. The resulting material was dried by evaporation and then calcined at 800° C. for 2 hours to produce a calcined material.

The produced calcined material was placed in a ball mill together with pure water, polyvinyl alcohol serving as a binder, a dispersant, a plasticizer, and PSZ balls, and mixed and milled. The mixed and milled slurry was dried into granules in a spray dryer to produce a granule powder.

The produced granule powder was press-molded into the following green compacts: H-shaped core samples that have, after molding, a dimension of 3.9 mm in the length direction L, a dimension of 2.8 mm in the width direction W, and a dimension of 2.2 mm in the height direction T, or ring-shaped samples that have, after molding, an outer diameter of 20 mm, an inner diameter of 12 mm, and a thickness of 1.5 mm.

The produced green compacts were fired at 1100° C. for 2 hours. Samples 1 to 25 were produced as described above.

The content of each element in each sample was measured by analyzing the composition of the corresponding sintered compact by ICP-AES/MS. The results are shown in Table 1. Table 1 shows the contents of the elements expressed in terms of the oxides of the elements.

The surface resistance of the ring-shaped samples of Samples 1 to 25 was measured by using a high resistance meter (4339A available from Agilent Technologies, Inc). The specific electrical resistance (log ρ) was calculated from the surface resistance and the sample dimensions. The average specific electrical resistance of each sample was calculated with n=5. The results are shown in Table 1. The samples having a specific electrical resistance of 1.0×10⁸ Ωm or more were rated A (good), and the samples having a specific electrical resistance of less than 1.0×10⁸ Ωm were rated B (poor).

The core samples of Samples 1 to 25 (20,000 core samples for each Sample) were subjected to barrel polishing at 80 rpm for 60 minutes. The core chipping rate was calculated by selecting 8,000 core samples and determining the presence of chips in the core samples after barrel polishing by using a substrate appearance inspection device (TWA-4101 available from Tokyo Weld Co., Ltd.). The samples exhibiting a core chipping rate of 0.15% or less in barrel polishing were rated A (good), and the samples exhibiting a core chipping rate of more than 0.15% were rated B (poor). The results are shown in Table 1.

Terminal electrodes were formed on the bottom surfaces of the core samples of Samples 1 to 25. Specifically, a Ag paste was applied to the bottom surface of a core sample and baked to form an underlying metal layer, and a plating layer including a Cu layer, a Ni layer, and a Sn layer was then formed by plating. The plating conditions were processing conditions under which the Cu layer, the Ni layer, and the Sn layer were respectively formed so as to have a thickness of 5 μm, 4 μm, and 15 μm were formed. A dimension of displacement of the plating layer from the intended position was measured as a plating elongation. The average plating elongation of each sample was calculated with n=10. The samples exhibiting a plating elongation of 70 μm or less were rated A (good), and the samples exhibiting a plating elongation of more than 70 μm were rated B (poor). The results are shown in Table 1.

The wire was bonded to the terminal electrodes on the core samples of Samples 1 to 25 by thermocompression bonding. Specifically, thermocompression bonding was performed at a pressure of 0.8 N by using a heater chip heated to 450° C. The crack generation rate was calculated by determining the presence of cracks in the core samples after thermocompression bonding by using a substrate appearance inspection device (TWA-4101 available from Tokyo Weld Co., Ltd.). The average crack generation rate of each sample was calculated with n=8,000. The samples exhibiting a crack generation rate of 0.20% or less in thermocompression bonding were rated A (good), and the samples exhibiting a crack generation rate of more than 0.20% were rated B (poor). The results are shown in Table 1.

TABLE 1

| | | | | | | | | | | | Specific |
|---|---|---|---|---|---|---|---|---|---|---|---|
| | | | | | | | | Core | | Crack | Electrical |
| Sample | Fe₂O₃ | CuO | ZnO | NiO | Mn₂O₃ | Nb₂O₅ | V₂O₅ | Chipping | Plating | Generation | Resistance |
| No. | (mol %) | (mol %) | (mol %) | (mol %) | (ppm) | (ppm) | (ppm) | Rate | Elongation | Rate | (Ωm) |
| *1 | 49.00 | 1.80 | 30.30 | 18.90 | 3000 | 20 | 35 | B | A | B | 1.0 × 10⁷ |
| 2 | 49.00 | 4.00 | 30.30 | 16.70 | 3000 | 20 | 35 | A | A | A | ≥1.0 × 10⁸ |
| 3 | 49.00 | 5.60 | 30.30 | 15.10 | 3000 | 20 | 35 | A | A | A | ≥1.0 × 10⁸ |
| 4 | 49.00 | 7.50 | 30.30 | 13.20 | 3000 | 20 | 35 | A | A | A | ≥1.0 × 10⁸ |
| *5 | 49.00 | 7.90 | 30.30 | 12.80 | 3000 | 20 | 35 | A | B | A | 1.0 × 10⁷ |
| *6 | 49.00 | 5.60 | 5.00 | 40.40 | 3000 | 20 | 35 | A | A | B | ≥1.0 × 10⁸ |
| 7 | 49.00 | 5.60 | 7.00 | 38.40 | 3000 | 20 | 35 | A | A | A | ≥1.0 × 10⁸ |
| 8 | 49.00 | 5.60 | 33.50 | 11.90 | 3000 | 20 | 35 | A | A | A | ≥1.0 × 10⁸ |
| *9 | 49.00 | 5.60 | 35.00 | 10.40 | 3000 | 20 | 35 | B | A | A | ≥1.0 × 10⁸ |
| *10 | 46.20 | 5.60 | 30.30 | 17.90 | 3000 | 20 | 35 | A | A | B | 1.0 × 10⁶ |
| 11 | 46.70 | 5.60 | 30.30 | 17.40 | 3000 | 20 | 35 | A | A | A | ≥1.0 × 10⁸ |
| 12 | 49.70 | 5.60 | 30.30 | 14.40 | 3000 | 20 | 35 | A | A | A | ≥1.0 × 10⁸ |
| *13 | 50.20 | 5.60 | 30.30 | 13.90 | 3000 | 20 | 35 | A | A | A | 1.0 × 10⁷ |
| *14 | 49.00 | 5.60 | 30.30 | 15.10 | 100 | 20 | 35 | A | A | B | ≥1.0 × 10⁸ |
| 15 | 49.00 | 5.60 | 30.30 | 15.10 | 300 | 20 | 35 | A | A | A | ≥1.0 × 10⁸ |
| 16 | 49.00 | 5.60 | 30.30 | 15.10 | 1000 | 20 | 35 | A | A | A | ≥1.0 × 10⁸ |
| *17 | 49.00 | 5.60 | 30.30 | 15.10 | 1200 | 20 | 35 | A | B | A | 1.0 × 10⁷ |
| *18 | 49.00 | 5.60 | 30.30 | 15.10 | 3000 | 0.5 | 35 | B | A | A | ≥1.0 × 10⁸ |
| 19 | 49.00 | 5.60 | 30.30 | 15.10 | 3000 | 2 | 35 | A | A | A | ≥1.0 × 10⁸ |
| 20 | 49.00 | 5.60 | 30.30 | 15.10 | 3000 | 30 | 35 | A | A | A | ≥1.0 × 10⁸ |
| *21 | 49.00 | 5.60 | 30.30 | 15.10 | 3000 | 100 | 35 | A | A | A | 1.0 × 10⁷ |
| *22 | 49.00 | 5.60 | 30.30 | 15.10 | 3000 | 20 | 3 | A | A | B | ≥1.0 × 10⁸ |
| 23 | 49.00 | 5.60 | 30.30 | 15.10 | 3000 | 20 | 10 | A | A | A | ≥1.0 × 10⁸ |
| 24 | 49.00 | 5.60 | 30.30 | 15.10 | 3000 | 20 | 60 | A | A | A | ≥1.0 × 10⁸ |
| *25 | 49.00 | 5.60 | 30.30 | 15.10 | 3000 | 20 | 100 | B | A | A | ≥1.0 × 10⁸ |

In Table 1, the samples with * marks are Comparative Examples outside the scope of the present disclosure.

Referring to Table 1, Samples 2 to 4, 7, 8, 11, 12, 15, 16, 19, 20, 23, and 24 containing Fe, Cu, Zn, Ni, Mn, Nb, and V in predetermined ranges provide ceramic compositions exhibiting a core chipping rate of 0.15% or less in barrel polishing, a crack generation rate of 0.20% or less in thermocompression bonding, a plating elongation of 70 μm or less, and a specific electrical resistance (log ρ) of 1.0×10⁸ Ωm or more.

### Example 2

Samples 26 to 29 having the same composition as Sample 3 in Table 1 but having grain sizes different from that of Sample 3 were produced by changing the firing temperature and evaluated in the same manner as in Example 1. The results are shown in Table 2.

The average grain size in the sintered state was calculated from the grain sizes calculated by the following method.

The H-shaped core samples of Samples 3 and 26 to 29 were subjected to polishing and surface flattening by using an automatic polishing device (Tegramin-25 available from Struers), and the polished surface was then observed by using a scanning electron microscope (SEM). The grain size was calculated from the SEM image of the polished surface by using image analyzing software WinROOF. The average value of grain sizes (n=50 or more) for each sample was calculated as the average grain size. The results are shown in Table 2.

TABLE 2

| | | Core | | Crack | Specific |
|---|---|---|---|---|---|
| | Grain | Chipping | Plating | Generation | Electrical |
| Sample | Size | Rate | Elongation | Rate | Resistance |
| No. | (μm) | (%) | (μm) | (%) | (Ωm) |
| 26 | 1.3 | 0.15% | 68 | 0.18% | ≥1.0 × 10⁸ |
| 27 | 2.2 | 0.09% | 65 | 0.16% | ≥1.0 × 10⁸ |
| 3 | 8.2 | 0.05% | 56 | 0.13% | ≥1.0 × 10⁸ |
| 28 | 9.0 | 0.06% | 59 | 0.11% | ≥1.0 × 10⁸ |
| 29 | 14.0 | 0.13% | 62 | 0.20% | ≥1.0 × 10⁸ |

Referring to Table 2, Samples 3, 27, and 28 having an average grain size of 2.2 μm or more and 9.0 μm or less (i.e., from 2.2 μm to 9.0 μm) in the sintered state exhibit a core chipping rate as low as 0.10% or less in barrel polishing.

### Example 3

Samples 30 to 33 having the same composition as Sample 3 in Table 1 except the Co content were produced and evaluated in the same manner as in Example 1. The Co content was measured by the same method as in Example 1. The results are shown in Table 3.

TABLE 3

| | | Core | | Crack | Specific |
|---|---|---|---|---|---|
| | | Chipping | Plating | Generation | Electrical |
| Sample | CoO | Rate | Elongation | Rate | Resistance |
| No. | (ppm) | (%) | (μm) | (%) | (Ωm) |
| 30 | 2 | 0.10% | 67 | 0.20% | ≥1.0 × 10⁸ |
| 31 | 500 | 0.11% | 59 | 0.13% | ≥1.0 × 10⁸ |
| 3 | 2000 | 0.05% | 56 | 0.13% | ≥1.0 × 10⁸ |
| 32 | 6000 | 0.07% | 44 | 0.10% | ≥1.0 × 10⁸ |
| 33 | 8000 | 0.13% | 65 | 0.18% | ≥1.0 × 10⁸ |

Referring to Table 3, Samples 3, 31, and 32 containing 500 ppm or more and 6,000 ppm or less (i.e., from 500 ppm to 6,000 ppm) of Co in terms of CoO exhibit a plating elongation as low as 60 μm or less. This may be because Co reduces the amount of Cu pushed out to the grain boundaries to increase the specific electrical resistance and thus to reduce plating elongation.

Although not shown in Table 1 for Example 1 and Table 2 for Example 2, Samples 1, 2, and 4 to 29 have Co contents similar to that of Sample 3.

What is claimed is:

1. A ceramic composition comprising Fe, Cu, Zn, Ni, Mn, Nb, and V, wherein
when amounts of Fe, Cu, Zn, and Ni are respectively expressed in terms of Fe₂O₃, CuO, ZnO, and NiO, and a total amount of Fe₂O₃, CuO, ZnO, and NiO is 100 mol %, the ceramic composition contains from 46.70 mol % to 49.70 mol % of Fe in terms of Fe₂O₃, from 4.00 mol % to 7.50 mol % of Cu in terms of CuO, and from 7.00 mol % to 33.50 mol % of Zn in terms of ZnO, with the balance being Ni, and
the ceramic composition contains from 300 ppm to 10,000 ppm of Mn in terms of Mn₂O₃, from 2 ppm to 30 ppm of Nb in terms of Nb₂O₅, and from 10 ppm to 60 ppm of V in terms of V₂O₅ with respect to 100 parts by weight of the total amount of Fe₂O₃, CuO, ZnO, and NiO.

2. The ceramic composition according to claim 1, wherein
the ceramic composition has an average grain size of from 2.2 μm to 9.0 μm in a sintered state.

3. The ceramic composition according to claim 1, further comprising:
from 500 ppm to 6,000 ppm of Co in terms of CoO with respect to 100 parts by weight of the total amount of Fe₂O₃, CuO, ZnO, and NiO.

4. A wire-wound coil component comprising:
a ceramic core including:
a winding core part extending in a length direction; and
a pair of flange parts on opposite end portions of the winding core part, the opposite end portions facing each other in the length direction, the flange parts each including:
an inner end surface facing the winding core part in the length direction;
an outer end surface opposite to the inner end surface in the length direction;
a pair of side surfaces facing each other in a width direction; and
a top surface and a bottom surface facing each other in a height direction;
a terminal electrode disposed at least on the bottom surface of each flange part of the ceramic core; and
a wire wound around the winding core part of the ceramic core and having end portions electrically connected to the respective terminal electrodes,
wherein the ceramic core includes the ceramic composition according to claim 1.

5. A wire-wound coil component comprising:
a ceramic core including:
a winding core part extending in a length direction; and
a pair of flange parts on opposite end portions of the winding core part, the opposite end portions facing each other in the length direction, the flange parts each including:
an inner end surface facing the winding core part in the length direction;
an outer end surface opposite to the inner end surface in the length direction;
a pair of side surfaces facing each other in a width direction; and
a top surface and a bottom surface facing each other in a height direction;
a terminal electrode disposed at least on the bottom surface of each flange part of the ceramic core; and
a wire wound around the winding core part of the ceramic core and having end portions electrically connected to the respective terminal electrodes,
wherein the ceramic core includes the ceramic composition according to claim 2.

6. A wire-wound coil component comprising:
a ceramic core including:
a winding core part extending in a length direction; and
a pair of flange parts on opposite end portions of the winding core part, the opposite end portions facing each other in the length direction, the flange parts each including:
an inner end surface facing the winding core part in the length direction;
an outer end surface opposite to the inner end surface in the length direction;
a pair of side surfaces facing each other in a width direction; and
a top surface and a bottom surface facing each other in a height direction;
a terminal electrode disposed at least on the bottom surface of each flange part of the ceramic core; and
a wire wound around the winding core part of the ceramic core and having end portions electrically connected to the respective terminal electrodes,
the ceramic core includes the ceramic composition according to claim 3.
